(19) United States
(12) Patent Application Publication
(10) Pub. No.: US 2007/0289647 A1
(43) Pub. Date: Dec. 20, 2007

(54) Mixer valve unit for liquids with associated flow rate meter, particularly for electrical domestic appliances

(75) Inventor: Paolo Ravedati, MONCALIERI (TORINO) (IT)

Correspondence Address: SUGHRUE MION, PLLC, 2100 PENNSYLVANIA AVENUE, N.W., SUITE 800, WASHINGTON, DC, 20037, US

(73) Assignee: ELBI INTERNATIONAL S.P.A.

(21) Appl. No.: 11/455,686

(22) Filed: Jun. 20, 2006

(51) Int. Cl. F16K 11/22

(52) U.S. Cl. 137/606

(57) ABSTRACT

The mixer valve unit includes a valve body having a first and a second inlet connector for connection to a source of hot water and a source of cold water respectively, and a manifold leading to an outlet connector; a first and a second electrically operated shut-off valve, interposed, respectively, between the first inlet connector and the outlet manifold, and between the second inlet connector and the outlet manifold, to permit, when open, the passage of a flow of hot water and a flow of cold water respectively between the first and the second inlet connector respectively and the outlet connector; a control unit for setting the valves selectively to one of a predetermined plurality of different operating modes; and a flow rate meter device directly connected to a connector of the valve body and capable of supplying electrical signals indicating the flow rate of the flow of water through this connector.

The present invention relates to a mixer valve unit for liquids, particularly for use in electrical domestic appliances where water is to be provided at different temperatures, as for example in washing machines or dishwashers.

The object of the present invention is to provide an improved mixer valve unit for liquids, which can make flows of water available at various temperatures to meet the widest range of operating requirements, with improved accuracy in respect of the quantitative dispensing of these fluids.

This and other objects are achieved according to the invention with a mixer valve unit for liquids comprising:
a valve body having
at least a first and a second inlet connector for connection to a source of hot water and a source of cold water respectively, and
a manifold leading to an outlet connector;
at least a first and a second electrically operated shut-off valve, interposed, respectively, between the first inlet connector and the outlet manifold, and between the second inlet connector and the outlet manifold, to permit, when open, the passage of a flow of hot water and a flow of cold water respectively between the first and the second inlet connector respectively and the outlet connector;
control means for setting the said valves selectively to one of a predetermined plurality of different operating modes; and
flow rate measurement means directly connected to a connector of the valve body and capable of supplying electrical signals indicating the flow rate of the flow of water through this connector.

In a preferred embodiment, the aforesaid flow rate measurement means comprise a turbine including a support structure which is stationary in operation, forming a passage in which a bladed rotor is rotatably mounted, and detection means associated with the said support structure and capable of supplying electrical signals indicating the speed of rotation of the said rotor.

The flow rate measurement means can be connected, in particular, to the outlet connector of the valve body, to supply electrical signals indicating the overall flow rate of the flow which can be provided through the valve unit, or can be connected to the second inlet connector of this valve body, to supply electrical signals indicating the flow rate of cold water through the valve unit.

Conveniently, according to a further characteristic, the aforesaid flow rate measurement means comprise at their inlet means for creating a uniform flow.

Further characteristics and advantages of the present invention will be made clear by the following detailed description, provided purely by way of example and without restrictive intent, with reference to the attached drawings, in which:

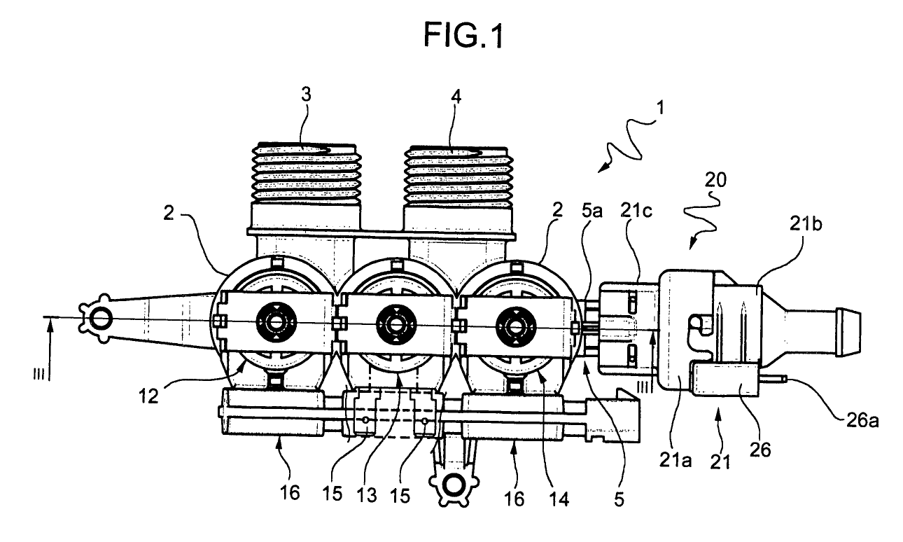

FIG. 1 is a plan view from above of a mixer valve unit for liquids according to the present invention;

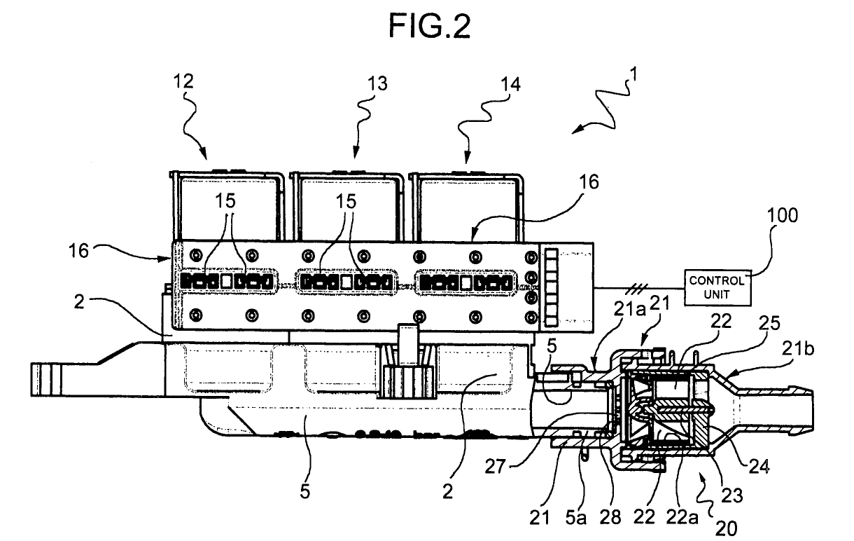

FIG. 2 is a side elevation of the valve unit of Figure

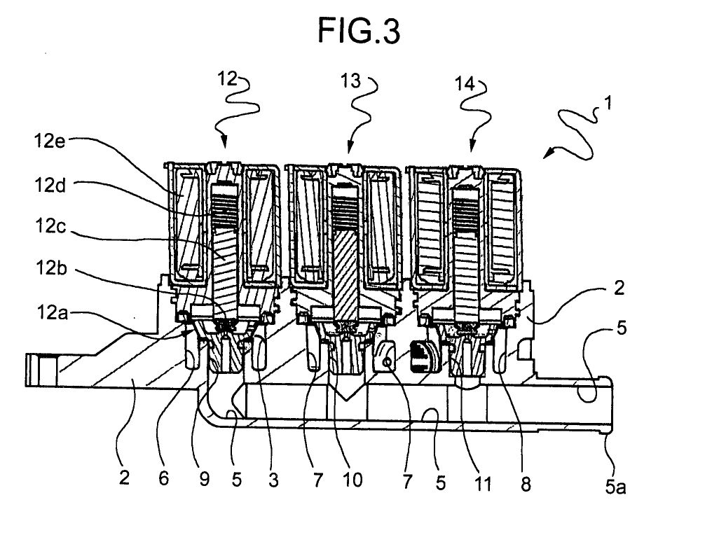

FIG. 3 is a partial sectional view taken along the line III-III of FIG. 1;

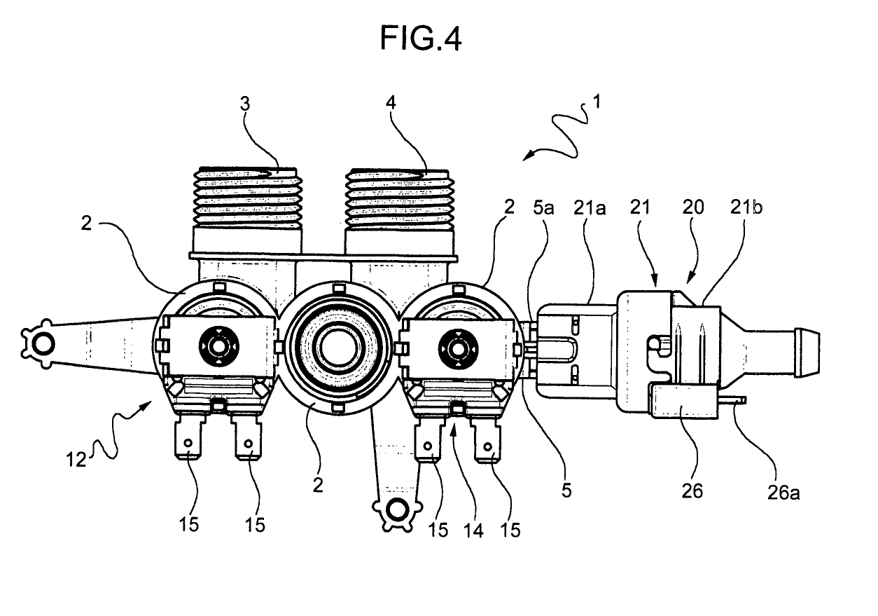

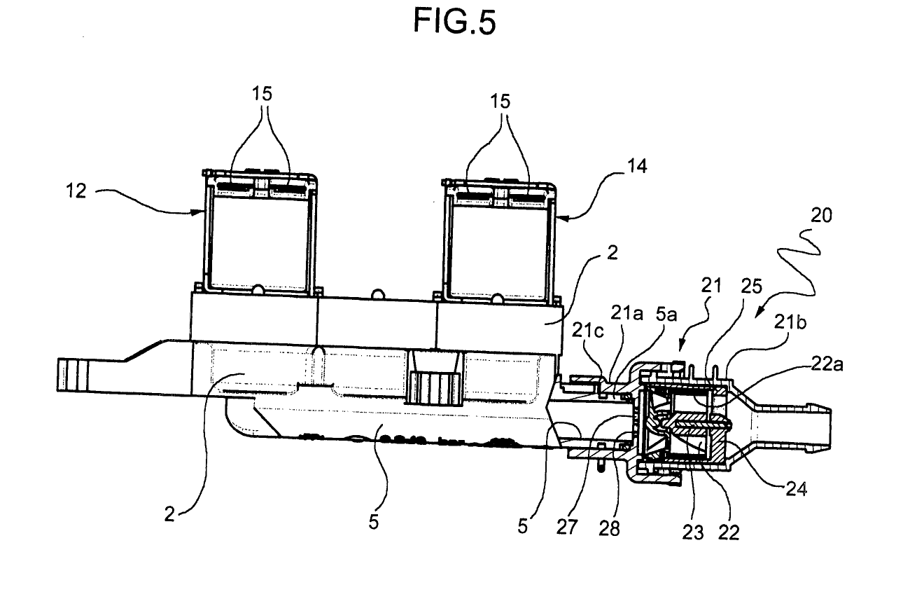

FIGS. 4 and 5 are views similar to those of FIGS. 1 and 2, and show a variant embodiment;

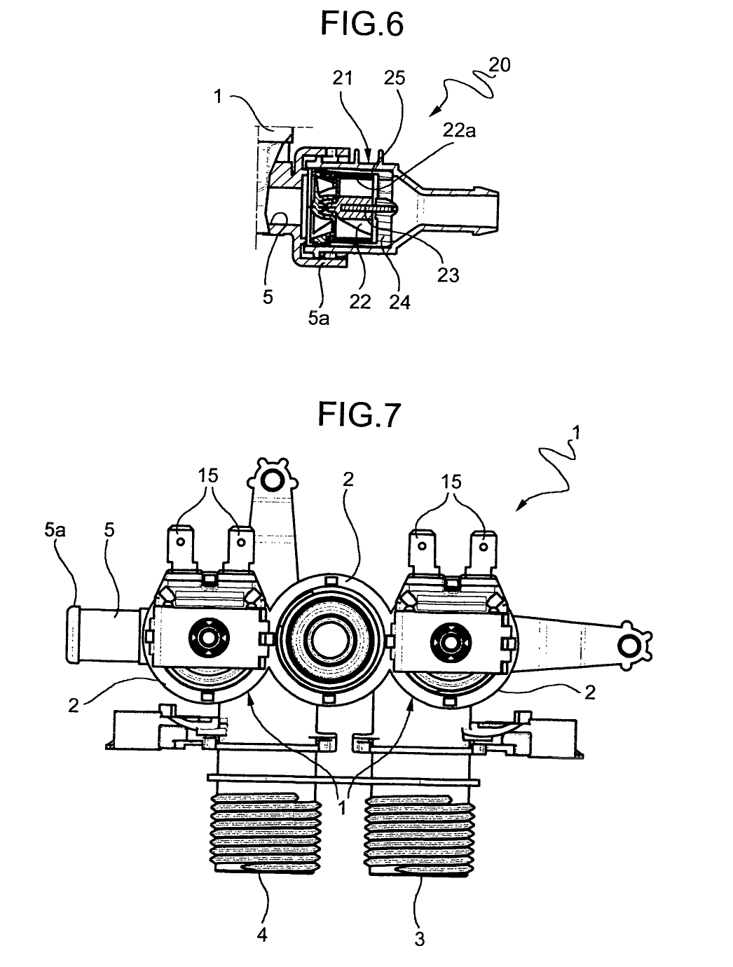

FIG. 6 is a partial sectional view, showing a variant embodiment of a flow rate meter device included in a mixer valve unit for liquids according to the invention;

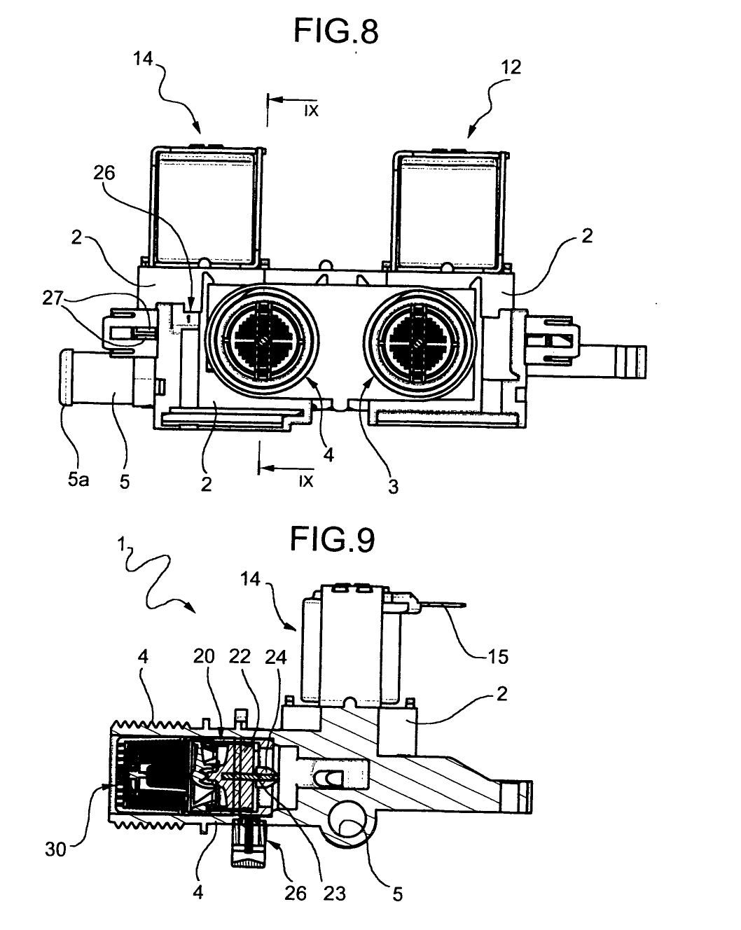

FIGS. 7 and 8 are views similar to those of FIGS. 4 and 5, and show a further variant embodiment;

FIG. 9 is a sectional view taken along the line IX-IX of FIG. 8;

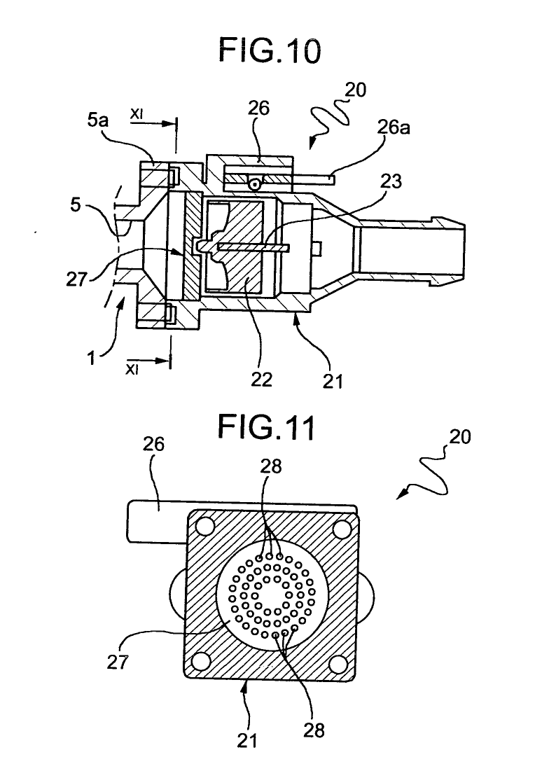

FIG. 10 is a partial sectional view, showing a further variant embodiment of a flow rate meter device included in a valve unit according to the invention;

FIG. 11 is a sectional view taken along the line XI-XI of FIG. 10;

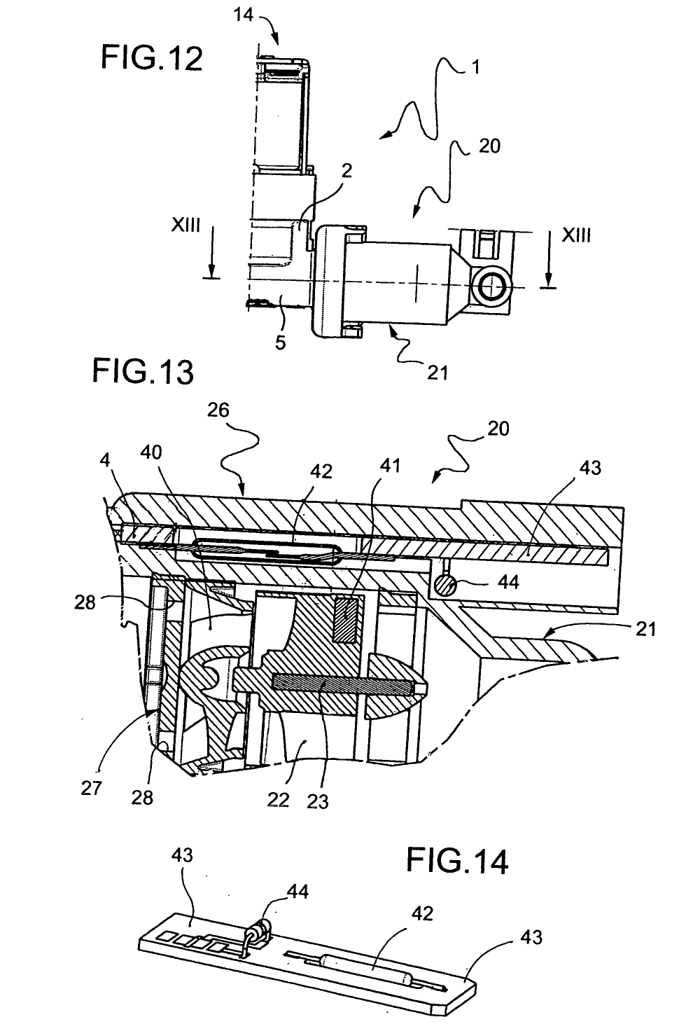

FIG. 12 is a partial side elevation of a further variant embodiment;

FIG. 13 is a partial sectional view on an enlarged scale, taken along the line XIII-XIII of FIG. 12; and

FIG. 14 is a perspective view of part of the flow rate meter device of FIGS. 12 and 13.

In FIGS. 1 to 3, the number 1 indicates the whole of a mixer valve unit for liquids according to the present invention. This valve unit comprises a valve body 2, made from moulded plastics material for example, having a first and a second inlet connector 3, 4 for connection, respectively, to a source of hot water and to a source of cold water which are not shown.

The valve body 2 also forms an outlet manifold, indicated by 5, having a corresponding terminal connector 5a.

With reference to FIG. 3, the valve body 2 has formed within it three chambers 6, 7 and 8, which can be made to communicate with the outlet manifold 5 through corresponding coaxial passages 9, 10 and 11.

The chamber 6 communicates with the inlet connector 3 for hot water, while chambers 7 and 8 both communicate with the inlet connector 4 for cold water.

The inlet 3 for hot water and the inlet 4 for cold water are connected to the chamber 6 and to chambers 7 and 8, respectively, through corresponding calibrated passages whose cross section is selected in such a way that the ranges of the corresponding flows of hot and cold water, respectively, are related to each other by ratios whose values lie within predetermined ranges, as explained more fully below.

The communication between the chambers 6, 7 and 8 and the outlet manifold 5 can be controlled by means of corresponding shut-off solenoid valves or on-off solenoid valves 12, 13 and 14, of the normally closed type. These solenoid valves are of a known type, and each has a corresponding main plug 12a, 13a, 14a including a membrane and interacting with a corresponding valve seat formed between the corresponding chamber 6, 7, 8 and the associated outlet passage 9, 10, 11. The main plug of the solenoid valve 12 has a corresponding axial passage normally shut off by an associated pilot plug 12b positioned above it and carried by a ferromagnetic core 12c on which a helical spring 12d acts inside an associated exciting coil 12e.

The structure of the solenoid valves 13 and 14 is substantially the same as that of the solenoid valve 12.

In the embodiment illustrated by way of example and without restrictive intent, all the solenoid valves 12, 13 and 14 extend parallel to each other with their corresponding directions substantially orthogonal to the outlet manifold 5. However, other relative positions of these solenoid valves are possible.

The solenoid valves 13 and 14 are hydraulically connected in parallel between the second inlet 4, for cold water, and the outlet manifold 5, and, when open, allow the passage of a first and a second flow of cold water respectively from the inlet connector 4 to the outlet manifold 5, with the respective specified flow rates which can be equal to or different from each other.

In the illustrated embodiment, the solenoid valves 12, 13 and 14 have corresponding pairs of electrical connecting terminals in the form of flat pins 15 (FIG. 1) aligned and coplanar with each other. These connecting terminals of the three solenoid valves 12-14 extend substantially in the same common plane, and are connected to an electrical connector indicated as a whole by 16 in FIGS. 1 and 2.

The mixer valve unit 1 is associated with a control unit 100 (FIG. 2), designed to set the solenoid valves 12-14 selectively to a plurality of different modes, to enable a flow of water at a temperature which can be at a plurality of predetermined levels to be obtained at the outlet 5 of the valve 1, according to the passage cross sections calibrated for the flow of water within the valve unit and according to the variation of the combinations of operation of the solenoid valves of the unit.

The control unit 100 is, for example, designed to set the solenoid valves 12-14 selectively to one of the following modes:
a) the valve 12 for hot water is open (ON), while the second and third valves 13 and 14 for cold water are closed (OFF);
b) the first valve 12 and the second valve 13 are open (ON), while the third valve 14 is closed;
c) the third valve 14 is open (ON), while the first and second valves 12 and 13 are both closed.

Modes a), b) and c) above provide a flow of water at the outlet manifold 5 having a maximum temperature in mode a), a minimum temperature in mode c), and an intermediate temperature in mode b).

Conveniently, the control unit 100 can be designed to set the valves 12-14 additionally to a further mode in which the first valve 12 and the third valve 14 are both open (ON), while the second valve 13 is closed, and/or to a mode in which the three valves 12-14 are simultaneously open (ON).

| Hot | | | | | |
|---|---|---|---|---|---|
| water | | | | | Outlet |
| valve | Cold water | Cold water | Flow rate | Flow rate | temperatures |
| 12(A) | valve 13(B) | valve 14(C) | ratio B/A | ratio C/A | (° F.) |
| ON | | | | | T1 = 135 |
| ON | ON | | 1.14–2.00 | | T2 = 90 ± 5 |
| ON | | ON | | 1.72–4.48 | T3 = 81 ± 7 |
| ON | ON | ON | 1.14–2.00 | 1.72–4.48 | T4 = 75 ± 5 |
| | | ON | | | T5 = 60 |

the first three columns show the states of the valves 12, 13 and 14 for the five operating modes described above (if the state is not shown, it is considered to be OFF). The fourth and fifth columns show preferred ranges of the ratios B/A and C/A, respectively, where A indicates the flow rate of hot water (valve 12), B indicates the flow rate of cold water through valve 13, and C indicates the flow rate of cold water through valve 14. The column farthest to the right of the table shows the corresponding temperature values T1-T5 found in the outlet manifold 5 for the five operating modes defined above.

Tables 2-6 below show the ranges of flow rate for the flows of cold water with respect to the flows of hot water, and the corresponding temperatures that can be obtained in the outlet manifold 5, for another five preferred modes of application of the invention. In these tables, the significance of the symbols is the same as that described above with reference to Table 1.

TABLE 2

| | | Cold | | | |
|---|---|---|---|---|---|
| Hot water | Cold water | water | | | Outlet |
| valve | valve | valve | Flow rate | Flow rate | temperatures |
| 12(A) | 13(B) | 14(C) | ratio B/A | ratio C/A | (° F.) |
| ON | | | | | T1 = 135 |
| ON | ON | | 0.37–0.66 | | T2 = 110 ± 5 |
| ON | | ON | | 1.14–2.7 | T3 = 90 ± 5 |
| ON | ON | ON | 0.37–0.66 | 1.14–2.7 | T4 = 80 + 5/−8 |
| | | ON | | | T5 = 60 |

TABLE 3

| Hot | Cold | | | | |
|---|---|---|---|---|---|
| water | water | Cold water | | | Outlet |
| valve | valve | valve | Flow rate | Flow rate | temperatures |
| 12(A) | 13(B) | 14(C) | ratio B/A | ratio C/A | (° F.) |
| ON | | | | | T1 = 135 |
| ON | ON | | 0.41–0.66 | | T2 = 110 + 3/−5 |
| ON | | ON | | 1.66–3.33 | T3 = 83 ± 5 |
| ON | ON | ON | 0.41–0.66 | 1.66–3.33 | T4 = 80 ± 5 |
| | | ON | | | T5 = 60 |

TABLE 4

| Hot | Cold | | | | |
|---|---|---|---|---|---|
| water | water | Cold water | | | Outlet |
| valve | valve | valve | Flow rate | Flow rate | temperatures |
| 12(A) | 13(B) | 14(C) | ratio B/A | ratio C/A | (° F.) |
| ON | | | | | T1 = 135 |
| ON | ON | | 0.07–0.25 | | T2 = 125 ± 5 |
| ON | | ON | | 1.12–1.83 | T3 = 92 ± 5 |
| ON | ON | ON | 0.07–0.25 | 1.12–1.83 | T4 = 90 ± 5 |
| | | ON | | | T5 = 60 |

TABLE 5

| | Cold | Cold | | | |
|---|---|---|---|---|---|
| | water | water | | | Outlet |
| Hot water | valve | valve | Flow rate | Flow rate | temperatures |
| valve 12(A) | 13(B) | 14(C) | ratio B/A | ratio C/A | (° F.) |
| ON | | | | | T1 = 135 |
| ON | ON | | 0.07–0.24 | | T2 = 125 + 5/−4 |
| ON | | ON | | 1.9–3.93 | T3 = 81 + 5/−6 |
| ON | ON | ON | 0.07–0.24 | 1.9–3.93 | T4 = 80 ± 5 |
| | | ON | | | T5 = 60 |

TABLE 6

| | Cold | | | | |
|---|---|---|---|---|---|
| Hot water | water | Cold water | | | Outlet |
| valve | valve | valve | Flow rate | Flow rate | temperatures |
| 12(A) | 13(B) | 14(C) | ratio B/A | ratio C/A | (° F.) |
| ON | | | | | T1 = 135 |
| ON | ON | | 0.67–1.13 | | T2 = 110 ± 5 |
| ON | | ON | | 2–4 | T3 = 80 ± 5 |
| ON | ON | ON | 0.67–1.13 | 2–4 | T4 = 75 ± 5 |
| | | ON | | | T5 = 60 |

With reference to FIGS. 1 and 2 in particular, the valve unit 1 is associated with a flow rate meter device indicated as a whole by 20. In the embodiment illustrated by way of example in these figures, the flow rate meter 20 is connected directly to the outlet connector 5a of the valve body 2, to supply during operation electrical signals indicating the flow rate of the flow of water through this connector.

The flow rate meter 20 which is illustrated comprises a turbine including a support structure 21 which is stationary in operation, including two tubular elements 21a and 21b for inlet and outlet respectively, interconnected by a bayonet connection (or other connection method of a known type).

In the illustrated embodiment, the tubular inlet element 21a forms a female inlet connector 21c, connected to the outlet connector 5a of the valve unit 2, which therefore acts as a male connector.

The flow rate meter 21 also comprises a bladed rotor 22, mounted rotatably on a stationary axial shaft 23. In the embodiment illustrated by way of example, this shaft is carried by a radial arm 24 fixed to a support cage 25 fixed in the tubular element 21b (FIG. 2).

In the illustrated embodiment, the rotor 22 has a peripheral ring 22a in which at least one element of permanent magnetic material is fixed in a known way which is not shown.

The flow rate meter 20 also comprises a detector 26 (FIG. 1), such as what is known as a reed relay, which in operation changes its state whenever the said at least one element of permanent magnetic material passes close to it. The detector 26 can be connected through connecting members 27 (FIG. 1) to a control unit, which can be the control unit 100 (FIG. 2) which is also associated with the valve unit 1, or a control unit of the electrical domestic appliance in which the valve unit 1 is incorporated.

In operation, the frequency of the signals supplied by the detector 26 is indicative of the speed of rotation of the rotor 22, and therefore of the flow rate of water through the flow rate meter device 20.

In a variant embodiment which is not shown, the flow rate meter device 20 is associated with an inlet connector 3 or 4 of the valve unit 1. In this case, in operation it supplies electrical signals indicative of the flow of hot water or cold water respectively present in the valve unit 1. On the basis of the previously known ratios between the flow rates of water associated with the different solenoid valves of the valve unit 1, the control unit to which the detector 26 of the flow rate meter is connected can deduce the information concerning the actual flow rate of water supplied to the outlet 5, 5a of the valve unit.

With reference to FIG. 2 again, in the embodiment illustrated therein the flow rate meter 21 comprises a device for creating a uniform flow, indicated by 27. This device essentially comprises a transverse disc formation, fixed to the tubular inlet element 21a and provided with a plurality of holes 28. In operation, these holes actually eliminate or at least greatly reduce the turbulence and vortex formation of the cold and/or hot flows originating from the inlet connectors of the valve unit 1; these flows, which originate from valves located at different distances from the outlet 5 of the valve unit 1, generally differ from each other in their characteristics of turbulence and vortex formation.

FIGS. 4 and 5 show a variant embodiment. In these figures, parts and elements described previously have been given the same reference numerals as those used previously.

The variant of FIGS. 4 and 5 essentially differs from the embodiment of FIGS. 1 to 3 in that the second solenoid valve 13 is not present. In the embodiment of FIGS. 4 and 5, in fact, the effect is equivalent to having an intermediate solenoid valve 13 permanently “OFF”, in other words permanently closed.

The variant of FIGS. 4 and 5 therefore enables a smaller range of temperatures of the outlet water flow to be provided.

The previous description of the association of a flow rate meter device 20 with the outlet connector, or with one of the inlet connectors 3 and 4, is also applicable to the variant of FIGS. 4 and 5.

FIG. 6 shows a further variant embodiment of the flow rate meter device 20 associated with a valve unit 1 according to the invention. In this embodiment, the flow rate meter 20 comprises a support body 21, of essentially tubular shape, in which a bladed rotor 22 is mounted rotatably on a shaft 23 within a stationary cage 25. The support body 21 of the flow rate meter device 20 is fitted and retained inside the outlet connector 5a of the manifold 5 of the valve body 1.

The solution shown in FIG. 6 can also be conveniently implemented in a similar way if the flow rate meter 20 is associated with the inlet connector or with the inlet connector 4.

FIGS. 7 to 9 show a further variant embodiment. In these figures also, parts and elements described previously have been associated with the same reference numerals as those used previously.

The variant of FIGS. 7-9 is similar to that of FIGS. 4 and 5, in that it does not have the intermediate solenoid valve associated with the inlet 4 for cold water. As shown more clearly in FIG. 9, in the embodiment illustrated therein a flow rate meter 20 is associated with the inlet connector 4 for cold water, and is, in particular, fitted and retained within it. An inlet filter 30 is provided in the connector 4, immediately upstream of the flow meter 20 in hydraulic terms.

A similar flow rate meter can be fitted in the inlet connector 3 for hot water, or in the outlet connector 5a associated with the terminal manifold 5.

Conveniently, the flow rate meter device 20 can be made in the form of a cartridge, of standardized dimensions, and the inlet connectors 3 and 4 and the outlet connector 5a can be shaped in such a way as to form within them a seat in which a flow rate meter device of this kind can be selectively placed.

FIGS. 10 and 11 show a further variant embodiment of a flow rate meter device 20 for a valve unit 1 according to the invention.

In the embodiment of FIGS. 10 and 11, the flow rate meter 20 comprises a support body 21 connected to the terminal connector 5a shaped in the form of a flange of the outlet manifold 5 of the valve unit 1. Immediately upstream of the bladed rotor 22, the flow rate meter 20 comprises a device for creating a uniform flow, made in the form of a disc 27 provided with a plurality of holes or apertures 28.

The connection between the support body 21 and the flange connector 5a can be made in a known way, by means of screws, rivets or the like.

FIGS. 12-14 show a further variant embodiment of the flow rate meter device 20 associated with the mixer unit 1. In these figures also, parts identical or substantially corresponding to parts described previously have been given the reference numerals used previously.

With particular reference to FIG. 13, the flow rate meter device 20 illustrated therein comprises a device for creating a uniform flow 27 in the form of a disc provided with a plurality of apertures or holes 28, followed by a flow diverter or guide device 40. In operation, this device guides the flow of mixed liquid towards the blades of a turbine 22 which is mounted rotatably on a shaft 23. The rotor 22 carries an element 41 of permanent magnetic material, which on each revolution switches the signal supplied by an associated detector 26. In the illustrated example of embodiment, this detector 26 comprises what is known as a bulb-type reed relay 42, mounted on a base or board 43. This base or board also carries a temperature sensor 44, such as an NTC (negative temperature coefficient) resistor, which in operation supplies a signal indicative of the temperature of the mixed flow which emerges from the flow rate meter device 20. The integration of the temperature sensor 44 into the flow rate meter device 20 is particularly advantageous.

Clearly, provided that the principle of the invention is retained, the forms of application and the details of construction can be varied widely from what has been described and illustrated purely by way of example and without restrictive intent, without thereby departing from the scope of protection of the invention as defined by the attached claims.

1. Mixer valve unit for liquids, comprising
a valve body having
at least a first and a second inlet connector for connection to a source of hot water and a source of cold water respectively, and
a manifold leading to an outlet connector;
at least a first and a second electrically operated shut-off valve, interposed, respectively, between the first inlet connector and the outlet manifold, and between the second inlet connector and the outlet manifold, to permit, when open, the passage of a flow of hot water and a flow of cold water respectively between the first and the second inlet connector respectively and the outlet connector;
control means for setting the said valves selectively to one of a predetermined plurality of different operating modes; and
flow rate meter means directly connected to a connector of the valve body and capable of supplying electrical signals indicative of the flow rate of the flow of water through this connector.

2. Valve unit according to claim 1, in which the said flow rate meter means comprise a turbine including a support structure which is stationary in operation and which forms a passage in which a bladed rotor is rotatably mounted, and detector means for supplying electrical signals indicative of the speed of rotation of the said rotor.

3. Valve unit according to claim 2, in which the said flow rate meter means are connected to the outlet connector of the valve body.

4. Valve unit according to claim 2, in which the said flow rate meter means are connected to an inlet connector of the valve body.

5. Valve unit according to claim 2, in which the said flow rate meter means comprise, at their inlet, means for creating a uniform flow.

6. Valve unit according to claim 1, in which the flow rate meter means comprise means for sensing the temperature of the liquid flowing through the said flow rate meter means.

7. Valve unit according to claim 2, in which the stationary support structure of the said flow rate meter means has a female inlet connector connected to a male connector of the valve body.

8. Valve unit according to claim 2, in which the stationary support structure of the said flow rate meter means is fitted and retained in a connector of the valve body.

9. Valve unit according to claim 7, in which the said flow rate meter means are made in the form of a cartridge, and in which a corresponding seat, in which the said cartridge can be selectively placed, is formed inside an inlet connector and the outlet connector of the valve body.
